(19) United States
(12) Patent Application Publication
(10) Pub. No.: US 2017/0107821 A1
(43) Pub. Date: Apr. 20, 2017

(54) Turbine wheel for a radial turbine

(71) Applicant: ATLAS COPCO ENERGAS GMBH, Koeln (DE)

(72) Inventor: Lukas Schwarz, Koeln (DE)

(21) Appl. No.: 15/290,236

(22) Filed: Oct. 11, 2016

(30) Foreign Application Priority Data
Oct. 14, 2015 (DE) 102015117463.4

(51) Int. Cl. F01D 5/04; F01D 5/34

(52) U.S. Cl. CPC F01D 5/048; F01D 5/34; F05D 2230/22; F05D 2240/30

(57) ABSTRACT

A turbine wheel for a radial turbine includes a rotationally symmetrical base plate and a flow chamber delimited by a hub disk and a cover disk, wherein the flow chamber connects an axial inner opening to a radial outer opening and is subdivided by turbine blades into flow channels. In a method for producing such a turbine wheel, the hub disk, the turbine blades and the cover disk are integrally formed on the base plate using additive production methods.

### CROSS-REFERENCE TO A RELATED APPLICATION

The invention described and claimed hereinbelow is also described in German Patent Application DE 10 2015 117 463.4, filed on Oct. 14, 2015. The German Patent Application, the subject matter of which is incorporated herein by reference, provides the basis for a claim of priority of invention under 35 U.S.C. 119(a)-(d).

### BACKGROUND OF THE INVENTION

The invention relates to a turbine wheel for a radial turbine including a rotationally symmetrical base plate and a flow chamber, which is delimited by a cover disk and a hub disk and which connects an axial inner opening to a radial outer opening and is subdivided by turbine blades into flow channels. The invention also relates to a method for producing such a turbine wheel.

Closed turbine wheels of this type, i.e., so-called cover disk rotors, have the advantage that the medium guided through the turbine flows through the turbine interior without having to come into contact with the outer walls of the turbine. This permits greater gap widths between the turbine wheel and the turbine housing, and therefore greater thermal expansions can be compensated for easily and without efficiency losses.

Turbine wheels are usually manufactured by material removal. In this case, however, limitations result with regard to the geometry of the turbine wheel that can be manufactured. For instance, milling tools cannot move into a closed flow chamber to any possible depth and maneuver therein. This rules out complex designs for cover disk rotors manufactured from a solid block, in particular in the case of small turbine wheels.

Therefore, it has been necessary, up to now, to prefabricate the hub disk so as to be open and having turbine blades situated thereon, and to place a finished cover disk thereon. This retrofitting is highly disadvantageous, however, due to the high notch effect and the material weakening which results when the cover disk is joined. In addition, additional mass must be expended on the turbine wheel and additional production tolerances can also result.

### SUMMARY OF THE INVENTION

The present invention overcomes the shortcomings of known arts, such as those mentioned above.

The present invention provides a closed turbine wheel for a radial turbine, which closed turbine wheel has less mass and greater precision and, a method for producing such a turbine wheel for a radial turbine.

In an embodiment, the turbine wheel is provided for a radial turbine in which the working medium flows radially with respect to the axis of rotation of the turbine wheel. The teaching according to the invention also applies to other radial-flow turbomachines, such as centrifugal fans, centrifugal pumps and centrifugal compressors. The impeller comprises a rotationally symmetrical base plate, wherein the base plate has a rotationally symmetrical main body, on which rotationally periodically situated or formed connection devices (such as, e.g., bores or channel toothing) also are provided.

A flow chamber is delimited by a cover disk and a hub disk, which connects an axial inner opening to a radial outer opening. The hub disk and the cover disk define the flow chamber in the axial direction and are advantageously designed so as to have a uniform thickness. The flow chamber is subdivided by turbine blades into flow channels.

According to the invention, at least the hub disk, the turbine blades and the cover disk are integrally formed on the base plate using additive production methods, i.e., by additive production. In such a method, material from a powdered raw material is locally joined, in order to obtain a desired shape. These include, in particular, selective melting and sintering techniques, such as, e.g., selective laser melting (SLM) and selective laser sintering (SLS), which also are suitable for producing metal structures from metal powder. Molded parts manufactured in this way differ structurally from molded parts manufactured by forging and/or material removal. In particular, no joints (as is the case with welding, for example) are present. As a result, great homogeneity of the produced workpiece is achieved. In addition, shapes which cannot be manufactured by using other production methods, due to their special shaping, e.g., undercuts, also can be generated by using additive production methods, i.e., by additive production.

Preferably, the turbine blades each extend up to the outer radial opening of the flow chamber. In this case, the flow channels delimited by two turbine blades in each case are subdivided by at least one intermediate wall, which likewise extends up to the outer radial opening of the flow chamber, into a plurality of sub-channels. The intermediate walls do not extend as far inwardly as the turbine blades, which preferably extend up to the inner axial opening of the flow chamber. Due to the arrangement of the intermediate walls, the expansion of the flow channels in the radial direction is counteracted by way of the flow channels being subdivided into sub-channels. The smaller cross-section of the sub-channels is advantageous in terms of the flow guidance of the turbine and for the manufacturing according to the invention, since, in the case of additive production, smaller overhangs are more easily manufactured without additional support constructions, which must be removed later, in a complicated manner.

Advantageously, the circumferential, outer, radial opening of the flow chamber is formed by a multiplicity of mouth openings of the flow channels and/or the sub-channels. The individual mouth openings are delimited on the boundary by the base plate, the cover disk and by wall surfaces which are formed by the outer ends of the turbine blades and/or the intermediate walls.

In these mouth openings, the wall surfaces advantageously transition, in a rounded transition, into the cover disk. The inner cross-section of the flow channels or the sub-channels preferably continuously extends the cross-section of the mouth openings.

In an embodiment, a circular arc segment, in particular a semicircle, is formed by the cover disk and the wall surfaces. In this case, the radius of the semicircle is adapted to the radius, in particular, which can be formed without support constructions, by the additive production method that is used, i.e., by additive production. As a result, temporary support structures within the flow channels and the sub-channels are dispensed with, which support structures would otherwise have to be removed, requiring a great deal of effort. The turbine wheel can therefore be used immediately after completion and without further post-treatments.

Preferably, the base plate has a central hub passage for accommodating a shaft. Adjacent thereto, the turbine wheel has a sleeve-shaped, central section which extends up to the base plate and adjoins the hub passage. On the side facing away from the base plate, the central section extends up to a flange-shaped section within the inner central opening of the flow chamber. The central section, the hub disk and the base plate enclose a hollow space. Due to the hollow space, material is saved during construction of the turbine wheel, which lowers the manufacturing costs and also improves the usability (due to a reduced mass, which reduces the load caused by centrifugal force, and due to a reduced moment of inertia). In the case of additive production methods, in which the product is manufactured from bulk quantities of a powdered material, in order enable unused powder material to be removed from the interior of the hollow space, this hollow space advantageously has openings which are not connected to the flow chamber. Advantageously, the openings lead into the flange surface, which is covered by a shaft section or a fastening means in the installed state of the turbine wheel.

In an embodiment, power transmission ribs are situated in the hollow space. These ribs extend from the central section to the back side of the hub disk, which faces away from the flow chamber and encloses the hollow space. The power transmission ribs have a wall thickness of approximately 0.5% to 1%, preferably approximately 0.6% of the outer diameter. The power transmission ribs extend over 25% to 50%, preferably approximately 30% of the height of the hollow space, in the longitudinal direction of the axis. Nevertheless, the power transmission ribs suffice for reliably dissipating the centrifugal forces occurring at high rotational speeds without the need for a substantial usage of material. The power transmission ribs also advantageously transition into the base plate.

In an embodiment, the power transmission ribs are each interrupted by recesses situated between webs extending in the direction of power transmission. Further material can be saved as a result.

In another embodiment, at least individual turbine blades and/or intermediate walls of the turbine wheel are slanted. This is considered to mean that a cut through a cylindrical surface, which is concentric to the axis of rotation of the turbine wheel, reveals an inclination with respect to a line parallel to the axis of rotation. The inclination also can be present only in sections (e.g., a turbine wheel slants only at its inner or outer end), but is straight at its other end. Due to the inclination of the blades, the fluidic properties of the associated flow channel or sub-channel are improved and, additionally, the torsional stiffness of the turbine wheel is increased. Turbine geometries of this type cannot be represented in conventional impellers.

In an embodiment, the turbine blades and, optionally, the intermediate walls, are slanted in such a way that the mouth openings of the flow channels are delimited by alternatingly slanted and axially parallel-oriented wall surfaces. In this case, a particularly high torsional stiffness accompanied by favorable flow properties has been demonstrated.

Preferably, the flow channels extending in the radial direction between the inner opening and the outer opening are curved in the circumferential direction and, the inner end of a turbine blade is offset with respect to its outer end by at least 45°, preferably at least 60°, in the circumferential direction. Cover disk rotors of this type are particularly advantageous for the flow properties, but they cannot be manufactured as one piece using conventional production methods.

The invention also provides a method for producing a turbine wheel for a radial turbine including a rotationally symmetrical base plate and a flow chamber, which is delimited by a cover disk and a hub disk and which connects an axial inner opening to a radial outer opening and is subdivided by turbine blades into flow channels. According to the invention, initially the base plate is shaped and then at least the hub disk, the turbine blades and the cover disk are integrally mounted onto the base plate by using additive production methods. Advantageously, the production of the rotationally symmetrical base plate includes at least one material-removing step.

Preferably, the additive production method is selective laser melting or selective laser sintering.

In an embodiment, the base plate is produced by turning a forged circular blank. Forged metal parts have particularly high solidity and are easily manufactured in simple basic shapes. Due to the turning, a high rotational symmetry of the main body of the base plate is achieved. In this manner, the base plate can be prefabricated particularly easily and favorably in conventional ways.

### BRIEF DESCRIPTION OF THE DRAWINGS

Further features and advantages of the invention will become apparent from the description of embodiments that follows, with reference to the attached figures, wherein:

FIG. 1 is a perspective representation of a partially cutaway turbine wheel constructed according to one embodiment of the invention;

FIG. 2 presents a top view of the FIG. 1 turbine wheel, along the turning axis;

FIG. 3A presents a side view of a partially cutaway turbine wheel of FIG. 1;

FIG. 3B presents a detailed view of the mouth openings in the embodiment according to FIGS. 1 to 3A;

FIG. 4A presents a view similar to that view presented in FIG. 3A, but in an alternative embodiment or the inventive turbine wheel; and

FIG. 4B presents a detailed view of the mouth opening according to the embodiment depicted in FIG. 4A.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

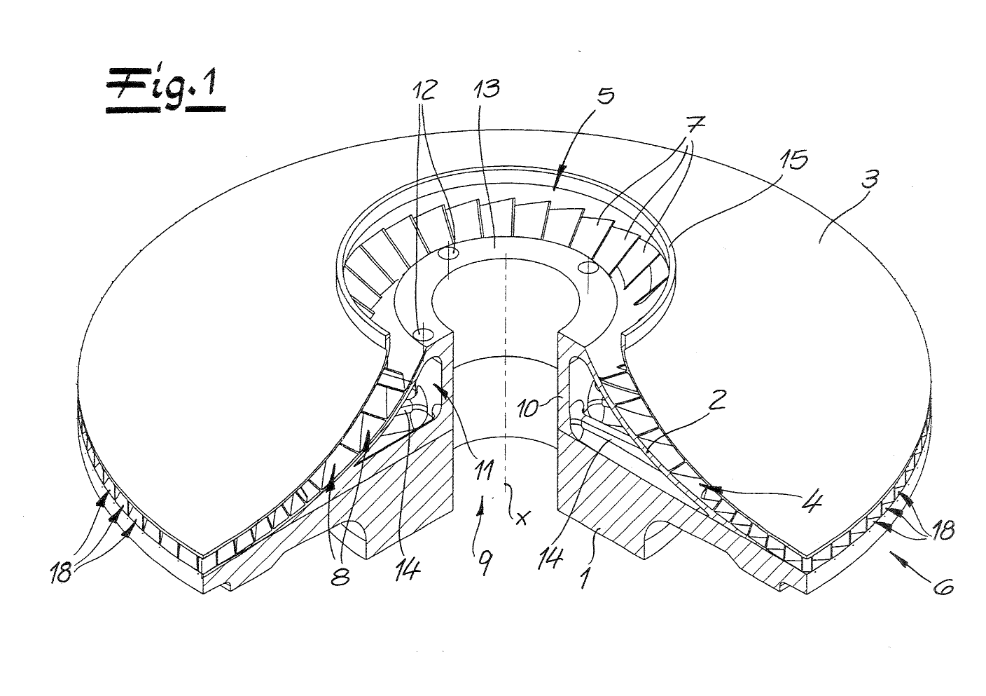

FIG. 1 depicts a turbine wheel constructed according to the invention. The FIG. 1 turbine wheel comprises a base plate 1, which has rotational symmetry about an axis of rotation x. Situated thereon is a flow chamber 4, which is delimited by a hub disk 2 and a cover disk 3. This flow chamber connects an axial inner opening 5 to a radial, circumferential, outer opening 6 of the turbine wheel. As is apparent on the radial cut surfaces, both the cover disk as well as the hub disk are formed having a substantially constant thickness in the extension from the inside to the outside. The hub disk 2 has a greater thickness than the cover disk 3 and transitions into the base plate 1 in the radially outer area. The flow chamber 4 is subdivided by turbine blades 7 into flow channels 8.

According to the invention, the hub disk 2, the turbine blades 7, and the cover disk 3 are integrally formed on the base plate 1 by using additive production methods.

The base plate 1 has a central hub passage 9 which is adjoined by a sleeve-shaped, central section 10 of the turbine wheel. The central section 10, the hub disk 2 and the base plate 1 enclose a hollow space 11. This hollow space has openings 12 which are situated on a flange-shaped section 13 which is formed by the axial end of the central section 10 and the hub disk 2 and is located within the inner axial opening 5 of the flow chamber.

Power transmission ribs 14 are situated within the hollow space 11, which ribs extend from the central section 10 to the back side of the hub disk 2 which faces away from the flow chamber 4 and encloses the hollow space 11.

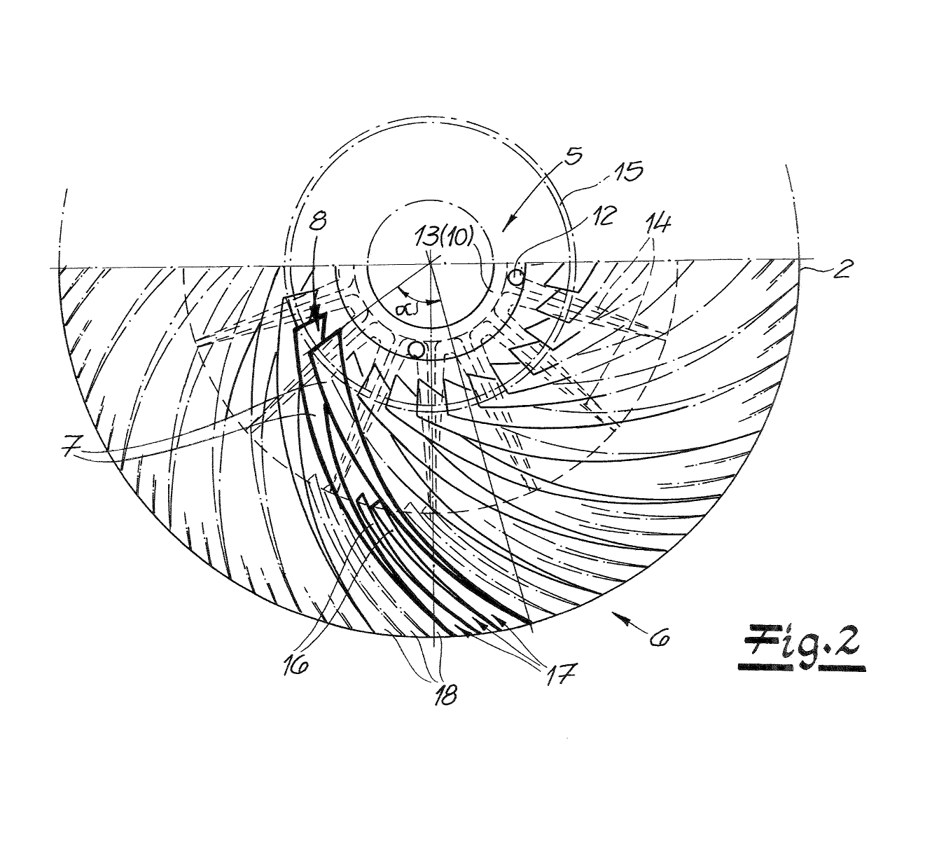

The cover disk 3, which would otherwise obscure the flow chamber 4 in the axial top view, is not shown in FIG. 2, for the sake of improved clarity. For the purpose of orientation, the ring 15 enclosing the axial inner opening 5 is merely indicated using a dash-dotted line. The flow channels 8 delimited by turbine blades 7 are apparent in the view. For the sake of improved understanding, a single, arbitrarily selected flow channel is shown with emphasis and is provided with reference numbers. The remaining turbine blades are merely indicated using a dash-dotted line.

The flow channel 8 is delimited on the outside by two turbine blades 7. These turbine blades extend from the inner axial opening 5 up to the outer radial opening 6 of the flow chamber 4. In a radially outer section, which makes up approximately one-half the extension of the flow channel 8, this flow channel is subdivided by two intermediate walls 16 into a total of three sub-channels 17. As a result, the expansion of the sub-channels 17 in the circumferential direction at the outer opening 6 is approximately as great as the expansion of the flow channel 8 at the inner opening 5. As is clear from the figure, both the turbine blades 7 and the intermediate walls 16 are slanted at their particular inner ends with respect to the axis of rotation x.

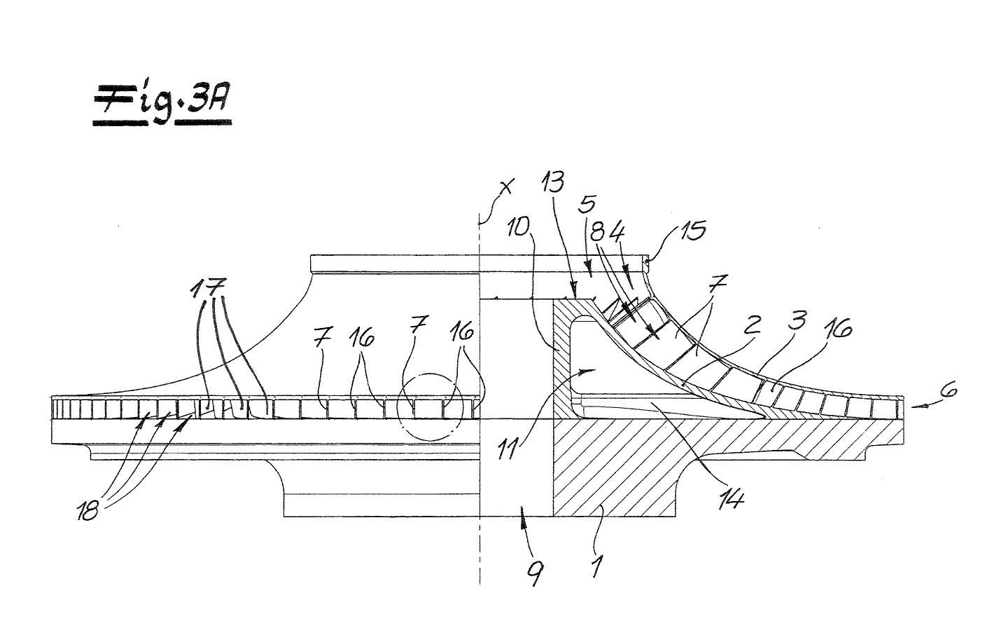

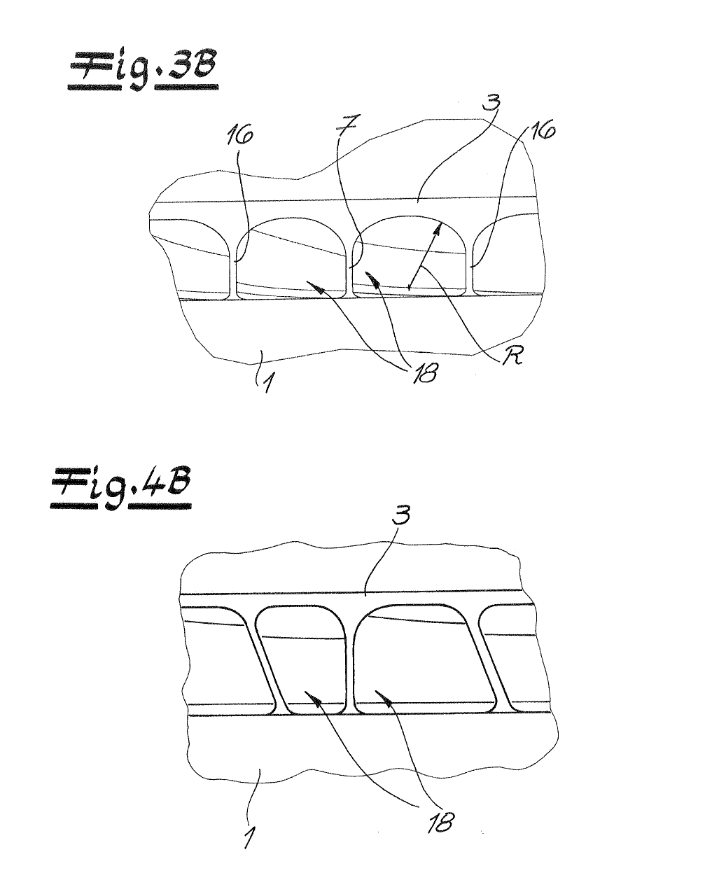

In contrast thereto, said turbine blades are oriented axially parallel, i.e., straight, on their outer end at the radial outer opening 6. The turbine blades 7 and the intermediate walls 16 extend in an arcuate shape. The offset a between the inner end of a turbine blade 7 and its outer end at the radial opening is approximately 60° in this case. Furthermore, the openings 12 leading into the hollow space 11 are shown in the figure. The power transmission ribs 14, which are situated in the hollow space and are largely covered by the hub disk 2, are indicated merely as dashed lines. A comparison of FIGS. 1 and 2 reveals that, in this exemplary embodiment, the power transmission ribs 14 are designed so as to each taper away from the central section 10 and the base plate 1. The turbine wheel according to the embodiment shown in FIGS. 1 and 2 is depicted in a side view in FIG. 3A. In this case, the right half is cutaway along a radial plane. In the left half, it is apparent that the circumferential, outer, radial opening 6 of the flow chamber 4 is formed by a multiplicity of mouth openings 18 of the flow channels 8 and/or the sub-channels 17. The individual mouth openings 18 are delimited on their circumference by the base plate 1, the cover disk 3 and by wall surfaces that are formed by the outer ends of the turbine blades 7 and/or the intermediate walls 16. As is evident from the enlarged section in FIG. 3B, the wall surfaces transition, in a rounded transition, into the cover disk 3. In this case, the cross-section of the mouth openings 18 continuously extends into the inner cross-section of the sub-channels 17. The transition between the cover disk 3 and the wall surfaces is formed by a circular arc segment having the radius R. The radius R in this case is the maximum of an overhang which does not comprise support constructions and which can be manufactured by using the additive production method which is used.

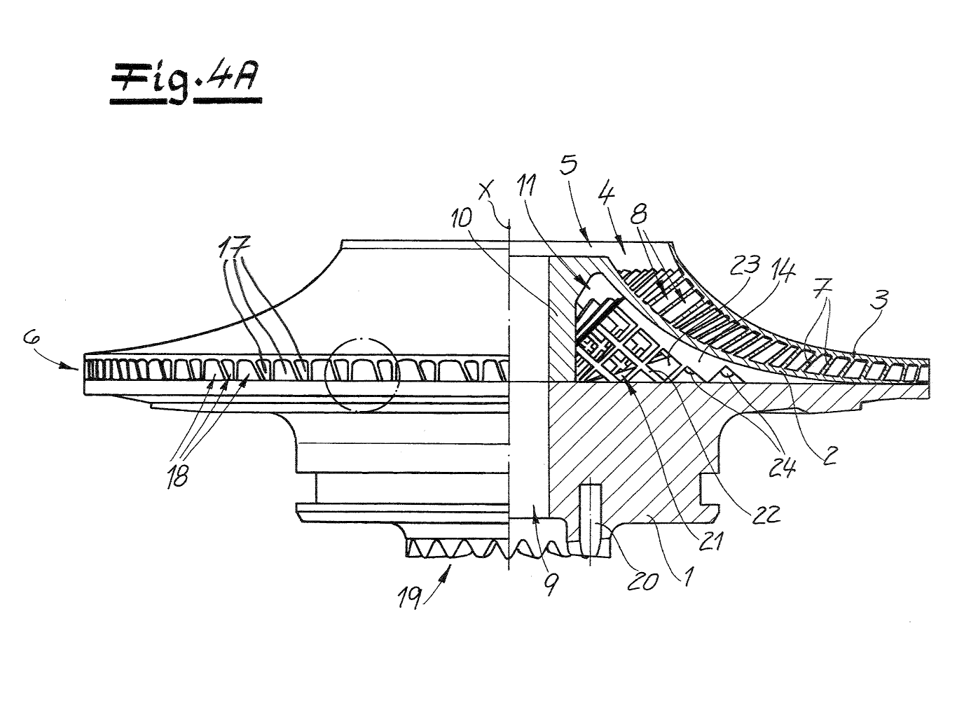

An embodiment of the inventive turbine wheel combines multiple mutually independent partial embodiments, and is depicted in FIGS. 4A and 4B. The substantially rotationally symmetrical base plate 1 has a channel toothing 19 on its end spaced apart from the flow chamber 4, for reliably coupling to a shaft. Furthermore, a bore 20 for accommodating a fixing screw is apparent in the cut half. In this alternative embodiment, the power transmission ribs 14 situated in the cutaway hollow space 11 are designed as planar elements having a uniform thickness. In this case, recesses 21 are provided in the power transmission ribs 14, which leave webs 22 extending in the direction of power flow. Furthermore, it is apparent that auxiliary ribs 23 are present, alternating between the power transmission ribs 14, and extend from the base plate 1 to the back side of the hub disk 2 in a triangular shape and are interrupted by round recesses 24. Comparing the left half of FIG. 4A with FIG. 4B (which shows an enlarged section of the outer opening 6), reveals that the turbine blades and the intermediate walls are slanted in such a way that the mouth openings of the flow channels 18 are delimited by alternatingly slanted and axially parallel-oriented wall surfaces. Nonetheless, the transitions between the wall surfaces and the cover disk are designed so as to be rounded.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A turbine wheel for a radial turbine, comprising:
a rotationally symmetrical base plate;
a hub disk;
a cover disk;
turbine blades; and
a flow chamber that is delimited by the hub disk and the cover disk, that is subdivided by the turbine blades into flow channels and that connects an axial inner opening to an outer radial opening;
wherein the hub disk, the turbine blades and the cover disk are integrally formed on the base plate using additive production methods.

2. The turbine wheel according to claim 1, wherein each of the flow channels is delimited by two turbine blades extending up to the outer radial opening of the flow chamber, is subdivided by at least one intermediate wall that extends up to the outer radial opening of the flow chamber, into a plurality of sub-channels in a radially outer area.

3. The turbine wheel according to claim 3, wherein the outer radial opening of the flow chamber is formed by a plurality of mouth openings of the flow channels, the sub-channels, or both, and wherein the mouth openings are delimited by the base plate, the cover disk and wall surfaces formed by the turbine blades, the at least one intermediate wall or both.

4. The turbine wheel according to claim 3, wherein within the mouth openings, the wall surfaces transition, in a rounded overhang, into the cover disk.

5. The turbine wheel according to claim 3, wherein a circular arc segment is formed by the cover disk and the at least one intermediate wall.

6. The turbine wheel according claim 1, wherein the base plate has a central hub passage for accommodating a shaft, the turbine wheel includes a sleeve-shaped, central section, which extends up to the base plate and adjoins the hub passage and the central section, the hub disk and the base plate enclose a hollow space.

7. The turbine wheel according to claim 6, further comprising power transmission ribs that extend from the central section to the hub disk, wherein the power transmission ribs are arranged in the hollow space.

8. The turbine wheel according to claim 7, wherein the power transmission ribs are each interrupted by recesses situated between webs extending in a direction of power transmission.

9. The turbine wheel according to claim 3, wherein at least individual ones of the turbine blades, the intermediate walls or both are slanted.

10. The turbine wheel according to claim 9, wherein the at least individual ones of the turbine blades, the intermediate walls or both are slanted in such a way that the mouth openings of the flow channels are delimited by alternatingly slanted and axially parallel-oriented wall surfaces.

11. The turbine wheel according to claim 1, wherein the flow channels extending in the radial direction between the inner opening and the outer opening are curved in the circumferential direction.

12. The turbine wheel according to claim 11, wherein an inner end of one of the turbine blades is offset with respect to its outer end by an angle a of at least 45° in a circumferential direction.

13. The turbine wheel according to claim 11, wherein an inner end of one of the turbine blades is offset with respect to its outer end by an angle a of at least 60° in a circumferential direction.

14. A method for producing a turbine wheel for a radial turbine comprising:
a rotationally symmetrical base plate;
a hub disk;
a cover disk;
turbine blades; and
a flow chamber that is delimited by the hub disk and the cover disk, that is subdivided by the turbine blades into flow channels and that connects an axial inner opening to an outer radial opening;
wherein the method comprises the acts of:
shaping the base plate; and
integrally mounting the hub disk, the turbine blades and the cover disk onto the base plate using an additive production method.

15. The method according to claim 14, wherein the additive production method used in the act of integrally mounted comprises selective laser melting or selective laser sintering.

16. The method according to claim 14, wherein the act of shaping the base plate includes turning a forged circular blank.
